(19) United States
(12) Patent Application Publication
(10) Pub. No.: US 2022/0286863 A1
(43) Pub. Date: Sep. 8, 2022

(54) METHODS FOR COGNITIVE PHYSICAL RANDOM ACCESS CHANNEL PLANNING AND RELATED APPARATUS

(71) Applicant: Telefonaktiebolaget LM Ericsson (publ), Stockholm (SE)

(72) Inventors: Debasish SARKAR, Frisco, TX (US); Surajit MONDAL, Bangalore (IN); Ayan SEN, Bangalore (IN)

(21) Appl. No.: 17/637,554

(22) PCT Filed: Aug. 23, 2019
(86) PCT No.: PCT/IB2019/057113

§ 371 Date: Feb. 23, 2022

(51) Int. Cl. H04W 16/10; H04W 24/02; H04W 74/00; H04W 16/18; H04W 74/08

(52) U.S. Cl. CPC H04W 16/10; H04W 24/02; H04W 74/002; H04W 16/18; H04W 74/085

(57) ABSTRACT

A method performed by a random access channel planning node. The random access channel planning node may identify a coverage overlap area of a candidate cell with each of the neighboring cells of the candidate cell in a radio access network. The random access channel planning node may use the identified coverage overlap area to determine a root sequence index for the candidate cell having a minimum root sequence index collision factor. The random access channel planning node may initiate a command to the candidate cell to set the root sequence index for the candidate cell to the determined root sequence index having the minimum root sequence index collision factor.

### TECHNICAL FIELD

The present disclosure relates generally to physical random access channel planning using a random access channel planning node in a communication network.

### BACKGROUND

Random access (RA) is a key initial procedure for multiple communication network events as described in 3GPP TS 38.300 R15. These network events may include:
Initial access from Radio Resource Connection Idle (RRC_IDLE);
RRC Connection Re-establishment procedure;
Handover;
Downlink (DL) or Uplink (UL) data arrival during RRC_CONNECTED when UL synchronization status is “non-synchronized”;
The transition from RRC_INACTIVE;
To establish time alignment at secondary cell (SCell) addition;
Request for other system information (SI); and
Beam failure recovery

End-user experience and various network performance indicators (such as accessibility, drop rate, latency or delay in access procedure, user bitrate, etc.) may be highly dependent on the performance of the above network events, which may be highly influenced by the success rate or delay associated with a RA procedure.

The importance of performance of the above network events and, thus, of a RA procedure further increases with the required network densification for 5G deployment with high-band frequency.

### SUMMARY

According to some embodiments of inventive concepts, a method performed by a random access channel planning node may be provided. The random access channel planning node may identify a coverage overlap area of a candidate cell with each of the neighboring cells of the candidate cell in a radio access network. The random access channel planning node may further use the identified coverage overlap area to determine a root sequence index for the candidate cell having a minimum root sequence index collision factor. The random access channel planning node may further initiate a command to the candidate cell to set the root sequence index for the candidate cell to the determined root sequence index having the minimum root sequence index collision factor.

According to some other embodiments of inventive concepts, a random access channel planning node may be provided. The random access channel planning node may include at least one processor, and at least one memory connected to the at least one processor to perform operations. The operations may include identifying a coverage overlap area of a candidate cell with each of the neighboring cells of the candidate cell in a radio access network. The operations may further include using the identified coverage overlap area to determine a root sequence index for the candidate cell having a minimum root sequence index collision factor. The operations may further include initiating a command to the candidate cell to set the root sequence index for the candidate cell to the determined root sequence index having the minimum root sequence index collision factor.

According to some embodiments, a computer program may be provided that includes instructions which, when executed on at least one processor, cause the at least one processor to carry out methods performed by the random access channel planning node.

According to some embodiments, a computer program product may be provided that includes a non-transitory computer readable medium storing instructions that, when executed on at least one processor, cause the at least one processor to carry out methods performed by the random access channel planning node.

Other systems, computer program products, and methods according to embodiments will be or become apparent to one with skill in the art upon review of the following drawings and detailed description. It is intended that all such additional systems, computer program products, and methods be included within this description and protected by the accompanying claims.

Operational advantages that may be provided by one or more embodiments may include lowering RACH collision probability, thus, improving RA procedure and subsequent event performance. A further potential advantage may be an effective user experience with decreased impact from the RA procedure. A further advantage may provide for an automated and autonomous method integrated with the network over the cloud without human effort to resolve RACH performance issues.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 illustrates cyclic shifts, Cᵥ, for an unrestricted set of root sequences;

FIG. 2 illustrates N_{cs} values for an unrestricted set of root sequences;

FIG. 3 is a flowchart illustrating operations of inner method A that may be performed by a random access channel planning node in accordance with some embodiments of the present disclosure;

FIG. 4 is a block diagram of operational modules and related circuits of a random access channel planning node in accordance with some embodiments of the present disclosure;

FIG. 5 is a logical diagram illustrating coverage overlaps between a candidate cell and neighboring cells;

FIG. 6 illustrates operations that may be performed by random access channel planning node 400 for RSI planning for a green-field network in accordance with some embodiments of the present disclosure;

FIG. 7 illustrates operations that may be performed by random access channel planning node 400 for coverage overlap detection based on predicted coverage polygon(s) in accordance with some embodiments of the present disclosure;

FIG. 8 illustrates an exemplary coverage overlap detection based on predicted coverage polygons from performing the operations of FIG. 7 in accordance with some embodiments of the present disclosure;

FIG. 9 is an exemplary RRC Reconfiguration message containing the information element rach-ConfigCommon setup;

FIG. 10 is a table showing exemplary sets of RSI groups created from 139 RSIs for R_{RSI}=8;

FIG. 11 is a logical diagram illustrating coverage overlap between a candidate cell and a neighboring cell based on geo-located measurement events from the candidate and neighbor cell;

FIG. 12 illustrates operations that may be performed by a random access channel planning node for coverage overlap detection based on geo-located measurement events from a candidate cell and neighbor cell in accordance with some embodiments of the present disclosure;

FIG. 13 illustrates cloud integration of random access planning node for a NR access communication network in accordance with some embodiments of the present disclosure;

FIG. 14 illustrates operations that may be performed by a random access channel planning node for cloud implementation; and

FIGS. 15-16 are flowcharts illustrating operations that may be performed by a random access channel planning node in accordance with some embodiments of the present disclosure.

### DETAILED DESCRIPTION

Various embodiments will be described more fully hereinafter with reference to the accompanying drawings. Other embodiments may take many different forms and should not be construed as limited to the embodiments set forth herein; rather, these embodiments are provided by way of example to convey the scope of the subject matter to those skilled in the art. Like numbers refer to like elements throughout the detailed description.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

One approach to try to ensure effective performance of the RA procedure is appropriate planning or allocation of Random Access Channel (RACH) Root Sequence Index (RSI) to minimize or reduce the probability of RSI collision.

One RACH root sequence can generate several preambles by cyclic shift. One or more root sequences may be needed to generate all required preambles in a cell. The number of RACH root sequences required to generate the desired number of RACH preambles depends on the applied cyclic shift. According to 3GPP TS 38.211 R15, there are 64 preambles defined in each time-frequency Physical Random Access Channel (PRACH) occasion, enumerated in increasing order of first increasing cyclic shift Cᵥ of a logical root sequence, and then in increasing order of the logical root sequence index, starting with the index obtained from the higher-layer parameter prach-RootSequenceIndex. Additional preamble sequences, in case 64 preambles cannot be generated from a single root Zadoff-Chu sequence, are obtained from the root sequences with the consecutive logical indexes until all the 64 sequences are found. The logical root sequence order is cyclic; the logical index 0 is consecutive to 837 when L_{RA}=839 and is consecutive to 137 when L_{RA}=139. The long sequence is used for subcarrier spacings 1.25 and 5 kHz and is used only for frequencies below 6 GHz. The short sequence is used for subcarrier spacings 15, 30, 60 and 120 kHz. 30 kHz is used for mid-band and 120 kHz is used for high-band. 3GPP TS 38.211 R15 indicates the possibility of 139 RACH Root Sequences for New Radio (NR) deployment with high-band. The cyclic shift Cᵥ has been defined in the below equation for an unrestricted set of root sequences.

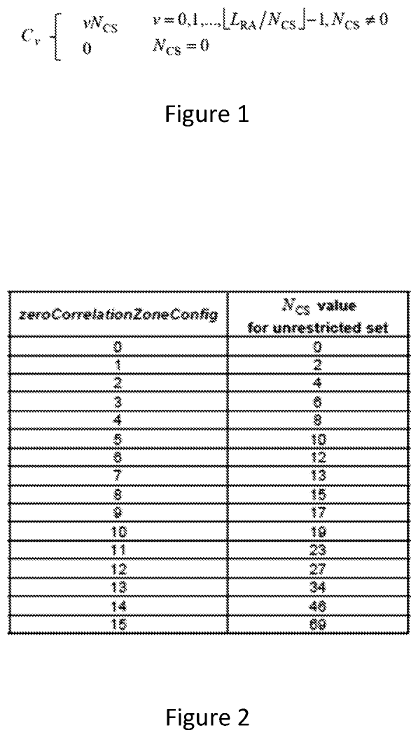

Cyclic shift Cᵥ has been defined in the equation shown in FIG. 1 for an unrestricted set of root sequences. In the equation of FIG. 1, N_{cs} is the minimum length of the cyclic shift duration and L_{RA}=139. The possible values of N_{cs} for the unrestricted set have been defined in the table shown in FIG. 2.

In LTE, there are a total of 839 RSIs. To reduce RSI conflicts, one approach for RSI allocation process or planning keeps the separation of a number of RACH root sequences required to generate the required number of preambles sufficient for desired cell range. Due to the relatively higher inter-site distance with lower frequency range (<6 GHz) and a higher number of available RSIs, this approach may minimize RACH collision and achieve acceptable RA performance.

3GPP TS 38.211 R15 indicates the possibility of 139 RACH Root Sequences for high-band. So, for NR deployment with a high-band total number of RSI is 139 and the inter-site distance is much lesser (e.g. 150-200 meters) compared to the same with frequency range <6 Ghz. Due to very closely placed sites, the probability of coverage overlap with neighboring cells is much higher. The degree of the problem also increases due to the multipath components of high-band signals.

Some approaches for RSI allocation and planning method may not be not sufficient to address this issue and a more intelligent method may be needed for SI allocation capable of achieving minimum possible RACH collision with a limited number of possible RACH root sequences.

Certain aspects of the present disclosure and their embodiments may provide solutions to these and/or other challenges. Various embodiments may provide apparatus and methods for (a) resolving RACH collision problems in an operational network, and (b) RSI planning in a green-field network, through the derivation of a collision factor metric (also referred to as a root sequence index collision factor or RSI collision factor). A collision factor metric may be calculated based on coverage overlap detection techniques applicable for both green-field RSI planning and an operational NR access network deployed with high-band. In some embodiments, through cloud implementation, RACH performance issues may be resolved automatically and autonomously without human intervention.

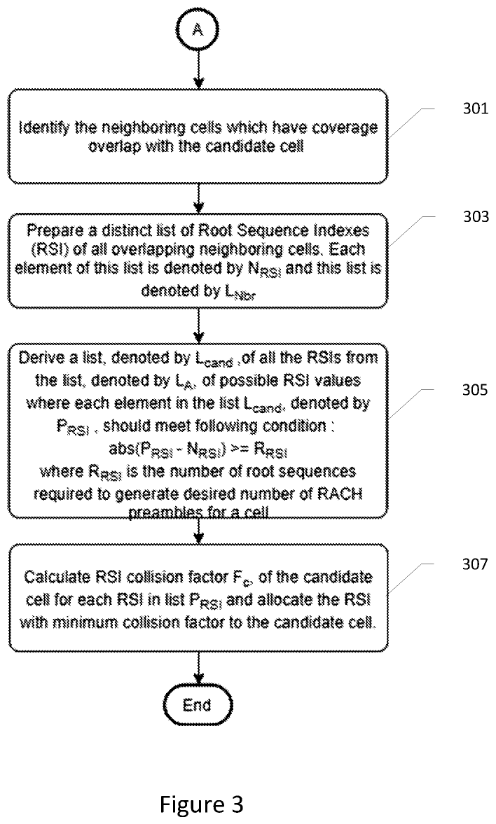

Various embodiments may provide a method for coverage overlap detection and RSI allocation (also referred to as inner method A) as illustrated in FIG. 3. Inner method A of FIG. 3 may be repeated for each candidate cell for which new RSI needs to be planned or RACH performance issue needs to be fixed. Inner method A may be adapted, as described in more detail below, for different environments including (a) green-field RSI planning, and (b) resolving RACH performance issues in an operational network.

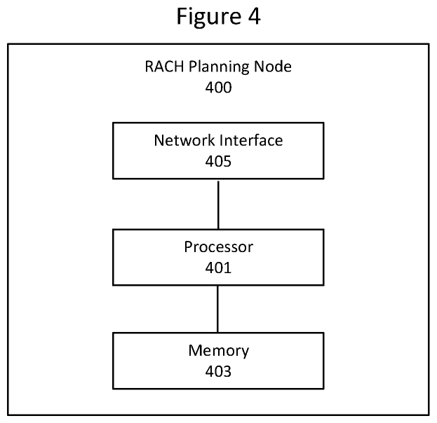

FIG. 4 is a block diagram illustrating elements of a random access channel planning node 400 (also referred to as RACH planning node 400) that is configured according to various embodiments. Random access channel planning node 400 may be located in a communication network either directly or indirectly via cloud integration. As shown, the random access channel planning node 400 includes at least one processor circuit 401 (also referred to as a processor), at least one memory circuit 403 (also referred to as memory), and a network interface 405 (e.g., a wired control interface and/or wireless control interface) configured to communicate with the communication network, e.g. with a node in a 5G communication network. Random access channel planning node 400 may be configured as a node in a radio access or wireless network, and may contain a RF front end with one or more power amplifiers that transmit and receive through antennas of an antenna array. The at least one memory 403 stores computer readable program code that when executed by the at least one processor 401 causes the processor 401 to perform operations according to embodiments disclosed herein.

Referring to FIG. 3, random access channel planning node 400 may perform operations according to inner method A. Random access channel planning node 400 may identify 301 neighboring cells which have coverage overlap with a candidate cell. Random access channel planning node 400 may prepare 303 a distinct list of root sequences indexes (RSI) of all overlapping neighboring cells. The distinct list may be referred to as a first list. Each element of the first list may be denoted by N_{RSI} and the first list may be denoted by L_{Nbr}.

Still referring to FIG. 3, random access channel planning node 400 may derive 305 a second list, denoted by L_{cand}, of all the RSIs from the first list, denoted by L_{A}, of possible RSI values where each element in the second list L_{cand}, denoted by P_{RSI}, should meet the following condition: abs(P_{RSI}−N_{RSI})≥R_{RSI}, where R_{RSI} is the number of root sequences required to generate a desired number of RACH preambles for a cell.

Still referring to FIG. 3, random access channel planning node 400 may calculate 307 a RSI collision factor, F_{c}, of the candidate cell for each P_{RSI} in the second list and allocate the RSI with a minimum RSI collision factor to the candidate cell.

Certain embodiments may provide one or more of the following technical advantages. A potential advantage of various embodiments may include lowering RACH collision probability, thus, improving RA procedure and subsequent event performance. A further potential advantage may be an effective user experience with decreased impact from the RA procedure. Some embodiments may provide for physical random access channel planning independent of the network product vendor. Some embodiments may further provide for an automated and autonomous method integrated with the network over the cloud without human effort to resolve RACH performance issues.

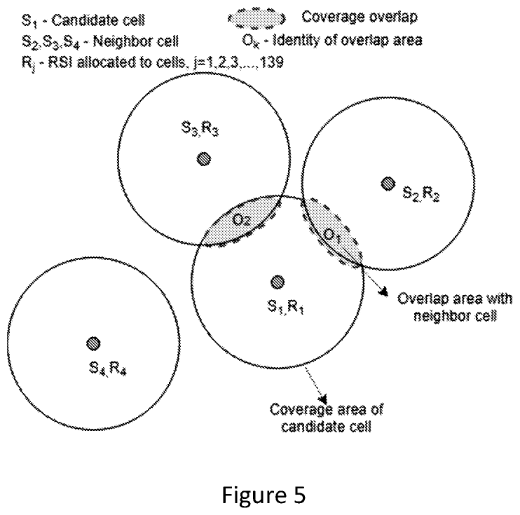

In various embodiments, inner method A of FIG. 3 may be illustrated with reference to FIG. 5. FIG. 5 shows a logical diagram illustrating coverage overlaps O₁ and O₂ between a candidate cell and neighboring cells S₂ and S₃, respectively. FIG. 5 illustrates an exemplary deployment of NR nodes having part of a cluster, Sᵢ, where n=1, 2, 3, 4 . . . , Nₛ (Nₛ=count of cells in the network), and Sᵢ denotes the cells or sectors. A candidate cell refers to the cell or sector for which RSI need to be planned. Rⱼ denotes the allocated RSI from available 139 RSIs.

Still referring to FIG. 5, S₁ is a candidate cell for which RSI needs to be planned. That is, R₁ needs to be identified so that S₁ does not have an RSI collision with neighboring cells S₂ and S₃. As shown in FIG. 5, candidate cell S₁ has a coverage overlap with neighbor cell S₂ and S₃; and neighbor cell S₄ does not have a coverage overlap with cell S₁.

Still referring to FIG. 5, a minimum RSI collision factor of a cell may be derived for each candidate cell during the allocation process.

The RSI collision factor, F_{c}, of a cell may be defined as follows:

$$Fc = \frac{\begin{matrix}{\sum }_{n = 1}^{x} Area of coverage overlap with \\ Neighbor cell with abs ( {P}_{RSI} - {N}_{n} ) < {R}_{RSI}\end{matrix}}{Total coverage area of candidate cell}$$

Where:

P_{RSI} is the RSI of the candidate cell;

Nₙ is the RSI of the neighbor cell having coverage overlap with the candidate cell; and

R_{RSI} is the number of root sequence required to generate the desired number of preambles for the candidate cell.

Still referring to FIG. 5, while allocating RSI for a candidate a cell, F_{c} is derived for each possible RSI and the RSI with minimum F_{c} is allocated to the candidate cell S₁.

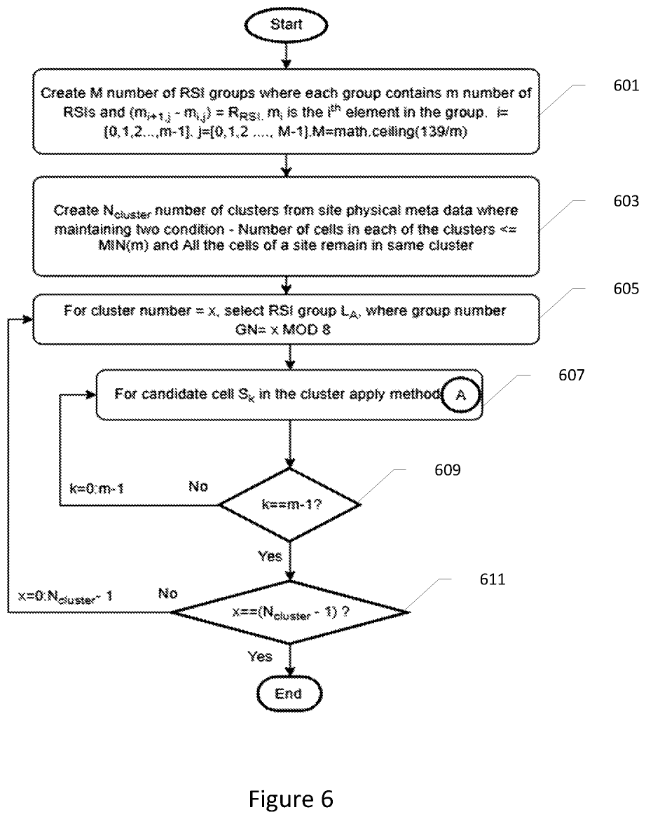

Greenfield RSI planning will now be described. FIG. 6 illustrates operations that may be performed by random access channel planning node 400 for RSI planning for a green-field network. Inner method A described with reference to FIG. 3 may be used for a green-field network with adaptions to fit available inputs for coverage overlap detection and reduce probability of RSI collision through usage of all 139 available RSI in a continuous manner.

Referring to FIG. 6, random access channel planning node 400 may create 601M number of RSI groups where each group contains m number of RSIs and (m_{i+1, j}−m_{i, j})=R_{RSI}; where mᵢ is the i^{th} element in the group, I+[0, 1, 2 . . . , m−1], j=[0, 1, 2 . . . , M−1], and M=match.ceiling(139/m).

Still referring to FIG. 6, random access channel planning node 400 may create 603 number of clusters, N_{cluster}, from site physical metadata where maintaining two conditions: Number of cells in each of the clusters ≤MIN(m); and all cells of a site remain in the same cluster. For cluster number=x, random access channel planning node 400 may select 605 RSI group L_{A}, where group number (GN) is GN=xMOD8.

Still referring to FIG. 6, random access channel planning node 400 may, for a candidate cell Sₖ in the cluster apply 607 inner method A. If k==m−1, random access channel planning node 400 may determine 611 whether x==(N_{cluster}−1). If k=0:m−1, random access channel planning node 400 may apply 607 inner method A for candidate cell Sₖ in the cluster. If k==m−1, random access channel planning node 400 may determine 611 whether x==(N_{cluster}−1). If random access channel planning node 400 determines 611 that x=0:(N_{cluster}−1), If k==m−1, random access channel planning node 400 may determine 611 whether x==(N_{cluster}−1). If random access channel planning node 400 may, for cluster number=x, select 605 RSI group L_{A}, where group number (GN) is GN=xMOD8. If random access channel planning node 400 determines 611 that x==(N_{cluster}−1), random access channel planning node 400 ends the operations of the method of FIG. 6.

To detect coverage-overlap of two cells, best coverage prediction plots from design tools may be used as an input. In the prediction plots, each cell may be represented by a polygon or multi-polygon object. Area of the coverage overlap may be calculated as the area of the intersection of two polygon(s) corresponding to the candidate cell and neighbor cell.

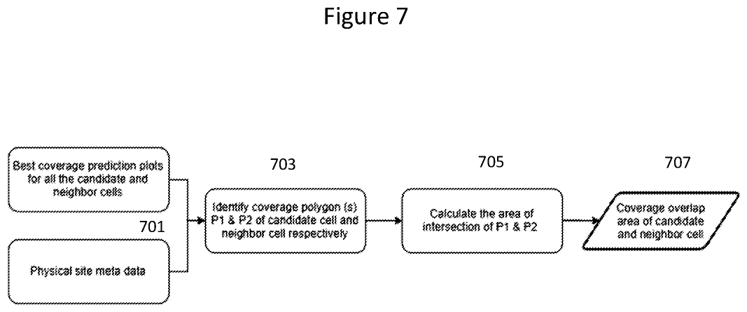

FIG. 7 illustrates operations that may be performed by random access channel planning node 400 for coverage overlap detection based on predicted coverage polygon(s). Referring to FIG. 7, input 701 to random access planning node 400, or to a node in communication with random access planning node 400, may include (1) best coverage production plots from a design tool(s) for all the candidate and neighbor cells, and (2) physical site meta data. Physical site meta data may include, but is not limited to, a location of the site (e.g., latitude and longitude of base station); azimuth of the a cell within a site; tilt angle of an antenna at the site; power of each radiating antenna at the site; height of an antenna at the site; type of antenna at the site; beam width of antenna at the site; etc.

Input 701 may be used to identify 703 coverage polygons (e.g., P1 and P2) of a candidate call and neighbor cell, respectively. The identified coverage polygons may be used to calculate 705 the area of intersection of the identified coverage polygons (e.g., area of intersection of P1 and P2). Calculation 705 results in a coverage overlap area 707 of the candidate cell and neighbor cell.

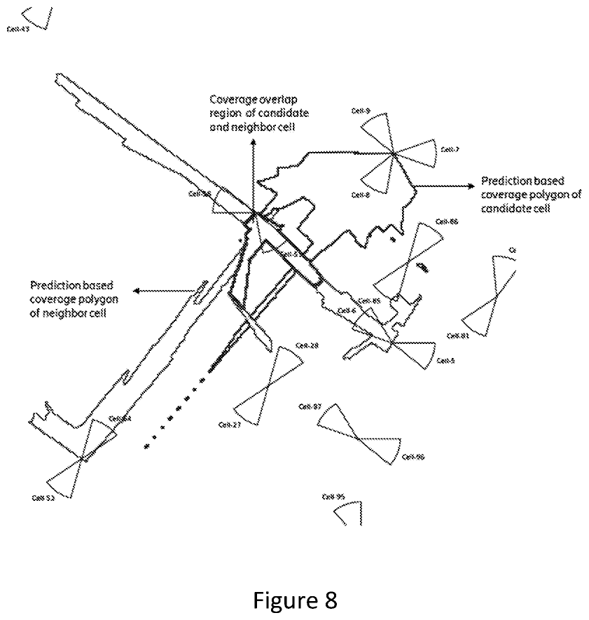

FIG. 8 illustrates an exemplary coverage overlap detection based on predicted coverage polygons from performing the operations of FIG. 7. Referring to FIG. 8, prediction based coverage polygons are identified for a candidate call and a neighbor cell, respectively. The identified prediction based coverage polygons were used to calculate the area of intersection of the identified polygons. The area of intersection of the identified polygons is shown in FIG. 6 by the area identified as coverage overlap region of candidate and neighbor cell.

For usage of all 139 RSI in a uniform manner in the exemplary coverage overlap of FIG. 8, the following method may be used.

All RSIs may be grouped into a number of groups, where the separation of RSIs in each group ≥R_{RSI}.

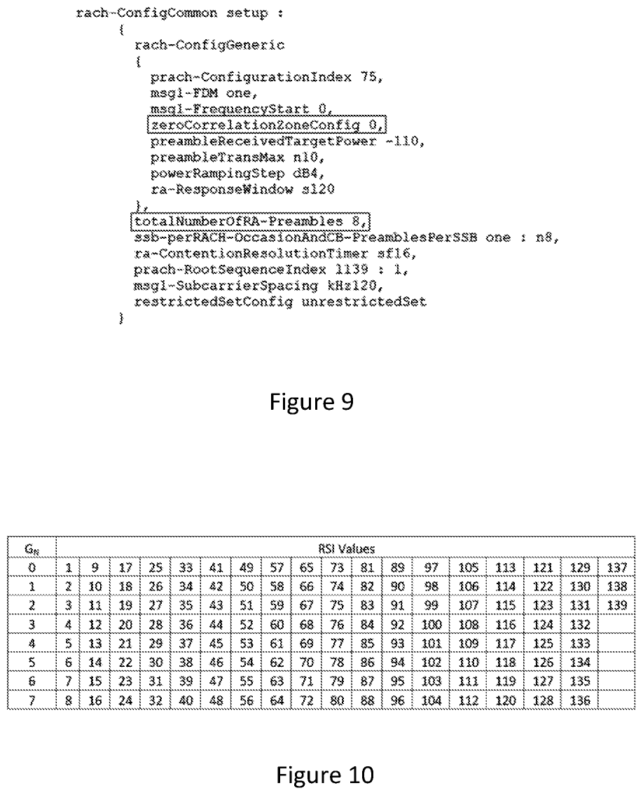

For mmW (High-Frequency bands above 6 GHz), 8 RACH preambles may be supported with NCS=0 and zeroCorrelationZoneConfig=0. These preambles are generated using a short sequence with L_{RA}=139. Hence R_{RSI}=8. An exemplary RRC Reconfiguration message containing the information element (IE) rach-ConfigCommon setup is shown in FIG. 9.

FIG. 10 illustrates a table showing exemplary sets of RSI groups created from 139 RSIs for R_{RSI}=8.

Using site physical metadata, a number of clusters (N_{cluster}) may be generated based on the nearest neighbor algorithm so that each cluster meets two requirements: (1) Number of cells in each of the clusters does not exceed 17; and (2) All the cells of a site remain in the same cluster.

An allocation process may iterate through each cluster sequentially and allocate RSI from a group of RSIs meeting the following condition:

G_{N}=n_{cluster} MOD 8

Where:
G_{N}=Group Number
n_{cluster}=Cluster number [0, 1, 2 . . . , N_{cluster}−1]

For example, if a cluster number is 9 then G_{N}=1 is used, i.e. L_{A} in FIG. 6 becomes L_{A}=[2, 10, 18, 26, 34, 42, 50, 58, 66, 74, 82, 90, 98, 106, 114, 122, 130, 138].

Resolving RACH collision in an operational network will now be described. An overall method for an operational network is similar to inner method A, with two adaptations described below.

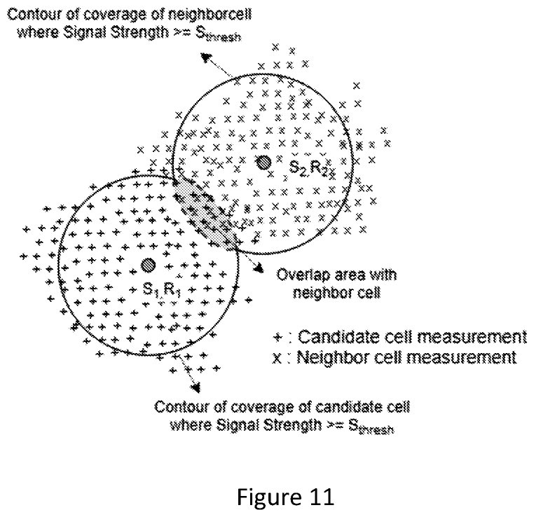

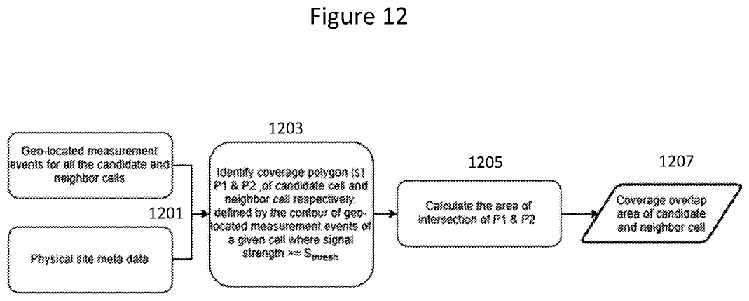

First, to detect a coverage-overlap between a candidate and neighbor cell, geo-located measurement reports may be used to identify a coverage-polygon of each cell. FIGS. 11 and 12 illustrate a method of detecting coverage overlap based on geolocated measurement events from a candidate and a neighbor cell. FIG. 11 illustrates an exemplary coverage overlap detection based on geo-located measurement events from a candidate cell and a neighbor cell. Referring to FIG. 11, the contour is shown of coverage of a candidate cell where signal strength ≥Sₜₕᵣₑₛₕ. The “+” marks shown in FIG. 11 illustrate candidate cell measurement events. FIG. 11 further illustrates the contour of coverage of a neighbor cell where signal strength ≥Sₜₕᵣₑₛ. An overlap area of the candidate cell with the neighbor cell is shown in the shaded area of FIG. 11.

FIG. 12 illustrates a process for coverage overlap detection based on geo-located measurement events from the candidate cell and neighbor cell illustrated in FIG. 11. Referring to FIG. 12, input 1201 to random access planning node 400, or to a node in communication with random access planning node 400, may include (1) geo-located measurement events for all the candidate and neighbor cells, and (2) physical site meta data. Physical site meta data may include, but is not limited to, a location of the site (e.g., latitude and longitude of base station); azimuth of the a cell within a site; tilt angle of an antenna at the site; power of each radiating antenna at the site; height of an antenna at the site; type of antenna at the site; beamwidth of antenna at the site; etc.

Input 1201 may be used to identify 1203 coverage polygons (e.g., P1 and P2) of a candidate call and neighbor cell, respectively, defined by the contour of geo-located measurement events of a given cell where signal strength ≥Sₜₕᵣₑₛ. The identified coverage polygons may be used to calculate 1205 the area of intersection of the identified coverage polygons (e.g., area of intersection of P1 and P2). Calculation 1205 results in a coverage overlap area 1107 of the candidate cell and neighbor cell

Second, unlike the method for green-field RSI planning, the selection of L_{A} in an operational network includes all 139 RSIs. Thus, in an operational network, L_{A}=[1, 2, 3, 4 . . . , 139] is used in inner method A.

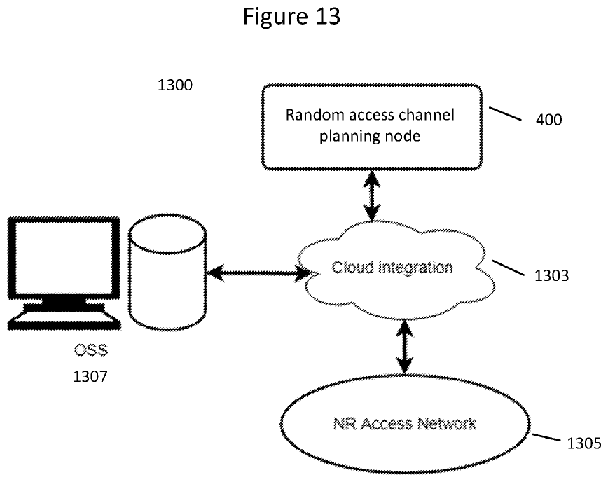

FIG. 13 illustrates cloud integration 103 of random access planning node 400 for a NR access communication network 1305 in accordance with some embodiments of the present disclosure. Random access planning node 400 may be used in a method to detect coverage overlap of a cell with a neighboring cell and use this information for RSI allocation with minimum or reduced probability of RACH collision. Coverage overlap detection may be performed in at least two ways. One method may be useful in RSI planning for green-field NR deployment, while the other method may be useful in resolving RACH collision in an operational NR network. As illustrated in FIG. 13, methods performed by random access channel planning node 400 may be deployed in the cloud by at least one processor 401 of random access channel planning node 400 performing operations by executing software.

While FIG. 13 illustrates a cloud implementation, random access channel planning node 400 may be located directly in a communication network, such as NR access network 1305. Random access channel planning node 400 may automatically perform methods described herein and may implement changes in network configuration in real-time.

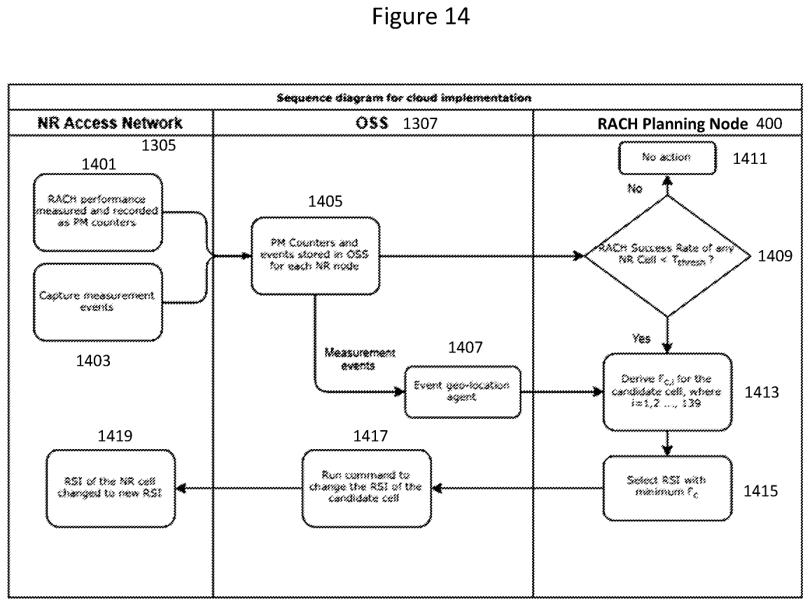

FIG. 14 illustrates a sequence diagram of operations and interactions of a NR access network/node 1305, an object storage service (OSS) 1307 in the cloud, and random access channel planning node 400, as configured for example in FIG. 13.

Referring to FIG. 14, a NR access network (e.g., a node of a communication network) 1305 may measure 1401 events including RACH performance and record 1401 the measurements as performance management (PM) counters of base stations/cells. The NR access network 1305 may capture 1403 the measurement events 1401. The measurements events of 1401 and 1403 may be provided to input of OSS 1307. OSS 1307 may store 1405 the PM counters and events for each NR node 1305. OSS 1307 may provide 1307 the measurement events to an event geo-location agent.

Still referring to FIG. 14, OSS 1307 also may provide the PM counters and measurement events to random access channel planning node 400. Random access channel planning node 400 may determine 1409 whether the RACH success rate of any NR cell is less than a threshold value, Tₜₕᵣₑₛₕ. If the RACH success rate of any NR cell is not less than the Tₜₕᵣₑₛ, no action 1411 may be taken.

If, however, the RACH success rate of any NR cell is greater than the Tₜₕᵣₑₛ, random access channel planning node 400 may derive 1413 F_{c}, for the candidate cell, where i=1, 2 . . . , 139. Random access channel planning node 400 may select the RSI with the minimum F_{c}.

Still referring to FIG. 14, random access channel planning node 400 may provide the selected RSI with the minimum F_{c} to OSS 1307. OSS 1307 may run and send 1417 a command(s) to NR access network 1305 to change the RSI of the candidate cell to the selected RSI with the minimum F_{c}. NR access network 1305 may change 1419 the RSI of the NR cell to the new RSI corresponding to the selected RSI with the minimum F_{c}.

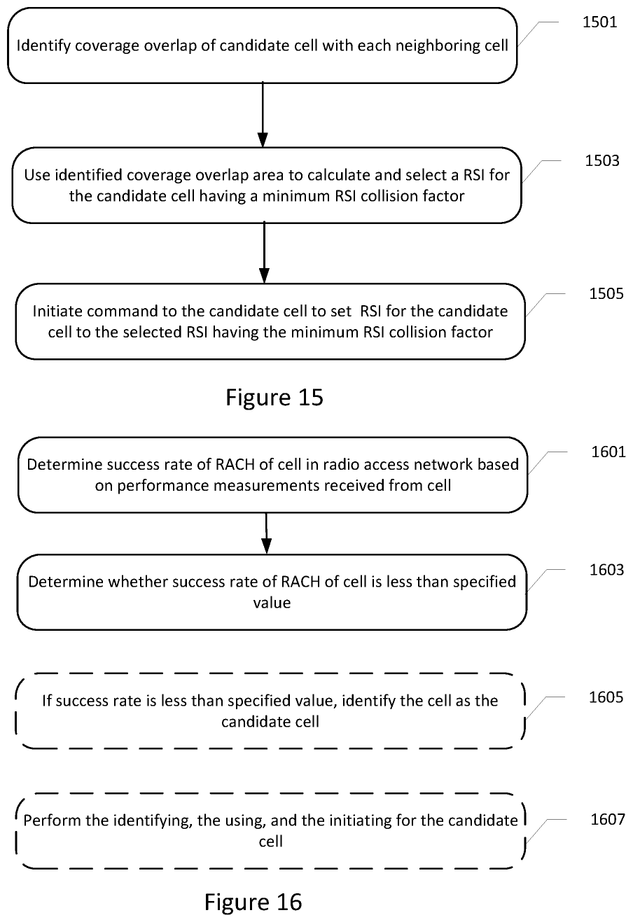

Operations of a random access channel planning node (implemented using the structure of the block diagram of FIG. 4) will now be discussed with reference to the flow charts of FIG. 15-16 according to some embodiments of inventive concepts. For example, modules may be stored in at least one memory 403 of FIG. 4, and these modules may provide instructions so that when the instructions of a modules are executed by at least one processor 401, at least one processor 401 performs respective operations of the flow charts.

Referring initially to FIG. 15, operations can be performed by a random access channel planning node (e.g., 400) in a communication network (e.g., 1305 in FIG. 13). The operations include identifying 1501 a coverage overlap area of a candidate cell with each of the neighboring cells of the candidate cell in a radio access network. The operations further include using 1503 the identified coverage overlap area to determine a root sequence index for the candidate cell having a minimum root sequence index collision factor. The operations further include initiating 1505 a command to the candidate cell to set the root sequence index for the candidate cell to the determined root sequence index having the minimum root sequence index collision factor.

Referring to FIG. 16, in at least some embodiments, the operations may further include determining 1601 a success rate of a random access channel of a cell in the radio access network based on performance measurements received from the cell. The operations may further include determining 1603 whether the success rate of the random access channel of the cell is less than a specified value.

In at least some embodiments, the operations may further include if the success rate of the random access channel of the cell is less than the specified value, identifying 1605 the cell as the candidate cell. The operations may further include performing 1607 the identifying, the using, and the initiating for the candidate cell.

The operations from the flow chart of FIG. 16 may be optional with respect to some embodiments.

Aspects of the present disclosure have been described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

It is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A method performed by a random access channel planning node in a communication network, the method comprising:
identifying a coverage overlap area of a candidate cell with each of the neighboring cells of the candidate cell in a radio access network;
using the identified coverage overlap area to determine a root sequence index for the candidate cell having a minimum root sequence index collision factor; and
initiating a command to the candidate cell to set the root sequence index for the candidate cell to the determined root sequence index having the minimum root sequence index collision factor.

2. The method of any of claim 1, wherein the using comprises:
preparing a first list of root sequence indexes for neighboring cells having coverage overlap areas with the candidate cell;
deriving a second list of the root sequence indexes from the first list, wherein the number of root sequence indexes in the second list is based on a defined number of root sequence indexes for generating a defined number of preambles for the candidate cell;
calculating a root sequence index collision factor for the candidate cell for each root sequence index in the second list; and
determining the root sequence index having the minimum root sequence index collision factor for the candidate cell.

3. The method of claim 1, wherein the identifying comprises:
for each of the candidate cell and the neighboring cells of the candidate cell, obtaining a coverage prediction plot and physical site meta data for the candidate cell and the neighboring cells for a greenfield radio access network;
for each of the candidate cell and the neighboring cells of the candidate cell, identifying a coverage polygon for the candidate cell and the neighboring cells of the candidate cell based on the coverage prediction plot and the physical site meta data for the candidate cell and the neighboring cells of the candidate cell;
calculating an area of intersection of the identified coverage polygons for the candidate cell and the neighboring cells of the candidate cell; and
identifying the calculated area of intersection as the coverage overlap area of the candidate cell with the neighboring cells of the candidate cell.

4. The method of claim 2, wherein the deriving a second list of the root sequence indexes from the first list comprises calculating a subset of the root sequence indexes, L_{CAND}, from the first list to generate a defined number of random access channel preambles for the candidate cell; and
wherein each root sequence index for the candidate cell, P_{RSI}, is included in the subset, L_{CAND}, so that an absolute value of a difference between each root sequence index for the candidate cell, P_{RSI}, and each root sequence index for a neighbor cell, N_{RSI}, having a coverage overlap area with the candidate cell, Nₙ, is less than R_{RSI}, the defined number of root sequence indexes for generating a defined number of preambles for the candidate cell.

5. The method of claim 4, wherein calculating the root sequence index collision factor for the candidate cell for each root sequence index in the second list comprises:
calculating the root sequence index collision factor, Fc, for each root sequence index included in the second list using the equation
$$Fc = \frac{\begin{matrix}{\sum }_{n = 1}^{x} Area of coverage overlap with \\ Neighbor cell with abs ( {P}_{RSI} - {N}_{n} ) < {R}_{RSI}\end{matrix}}{Total coverage area of candidate cell} .$$

6. The method of claim 1, further comprising:
creating a plurality of groups of all root sequence indexes for all cells of the greenfield radio access network, wherein each group has a group number and includes a defined subset of all of the root sequence indexes;
generating a number of clusters of all of the cells of the greenfield radio access network based on physical site meta data of all of the cells, wherein each cluster comprises a subset of all of the cells defined by the minimum count of root sequence indexes in the created groups and where all cells of a site of the greenfield communication network remain in the same cluster;
for each cluster, selecting the group number that is equal to (cluster number) MOD (the defined number of random access channel preambles for the candidate cell);
repeating for a cluster candidate cell in each cluster, the identifying, the using, and the initiating for the cluster candidate cell in each cluster.

7. The method of claim 1, wherein the identifying comprises:
for each of the candidate cell and the neighboring cells of the candidate cell, obtaining geo-located measurements and physical site meta data from the communication network for the candidate cell and the neighboring cells of the candidate cell for an operational radio access network;
for each of the candidate cell and the neighboring cells of the candidate cell, identifying a coverage polygon of the candidate cell and the neighboring cells of the candidate cell based on a contour of the geo-located measurements and the physical meta data for the candidate cell and the neighboring cells of the candidate cell where signal strength is greater than or equal to a defined signal strength;
calculating an area of intersection of the identified coverage polygons for the candidate cell and the neighboring cells of the candidate cell; and
identifying the calculated area of intersection as the coverage overlap area of the candidate cell with the neighboring cells of the candidate cell.

8. The method of claim 7, wherein the deriving the second list of root sequence indexes from the first list comprises all of the root sequence indexes from the first list.

9. The method of claim 1, further comprising:
determining a success rate of a random access channel of a cell in the radio access network based on performance measurements received from the cell; and
determining whether the success rate of the random access channel of the cell is less than a specified value.

10. The method of claim 9, further comprising:
if the success rate of the random access channel of the cell is less than the specified value, identifying the cell as the candidate cell; and
performing the identifying, the using, and the initiating for the candidate cell.

11. A random access channel planning node, the random access planning node comprising:
at least one processor; and
at least one memory connected to the at least one processor and storing program code that is executed by the at least one processor to perform operations comprising:
identifying a coverage overlap area of a candidate cell with each of the neighboring cells of the candidate cell in a radio access network;
using the identified coverage overlap area to determine a root sequence index for the candidate cell having a minimum root sequence index collision factor; and
initiating a command to the candidate cell to set the root sequence index for the candidate cell to the determined root sequence index having the minimum root sequence index collision factor.

12. The random access channel planning node of claim 11, wherein the using comprises:
preparing a first list of root sequence indexes for neighboring cells having coverage overlap areas with the candidate cell;
deriving a second list of the root sequence indexes from the first list, wherein the number of root sequence indexes in the second list is based on a defined number of root sequence indexes for generating a defined number of preambles for the candidate cell;
calculating a root sequence index collision factor for the candidate cell for each root sequence index in the second list; and
determining the root sequence index having the minimum root sequence index collision factor for the candidate cell.

13. The random access channel planning node of claim 11, wherein the identifying comprises:
for each of the candidate cell and the neighboring cells of the candidate cell, obtaining a coverage prediction plot and physical site meta data for the candidate cell and the neighboring cells for a greenfield radio access network;
for each of the candidate cell and the neighboring cells of the candidate cell, identifying a coverage polygon for the candidate cell and the neighboring cells of the candidate cell based on the coverage prediction plot and the physical site meta data for the candidate cell and the neighboring cells of the candidate cell;
calculating an area of intersection of the identified coverage polygons for the candidate cell and the neighboring cells of the candidate cell; and
identifying the calculated area of intersection as the coverage overlap area of the candidate cell with the neighboring cells of the candidate cell.

14. The random access channel planning node of claim 12, wherein the deriving a second list of the root sequence indexes from the first list comprises calculating a subset of the root sequence indexes, L_{CAND}, from the first list to generate a defined number of random access channel preambles for the candidate cell; and
wherein each root sequence index for the candidate cell, P_{RSI}, is included in the subset, L_{CAND}, so that an absolute value of a difference between each root sequence index for the candidate cell, P_{RSI}, and each root sequence index for a neighbor cell, N_{RSI}, having a coverage overlap area with the candidate cell, Nₙ, is less than R_{RSI}, the defined number of root sequence indexes for generating a defined number of preambles for the candidate cell.

15. The random access channel planning node of claim 14, wherein calculating the root sequence index collision factor for the candidate cell for each root sequence index in the second list comprises:
calculating the root sequence index collision factor, Fc, for each root sequence index included in the second list using the equation
$$Fc = \frac{\begin{matrix}{\sum }_{n = 1}^{x} Area of coverage overlap with \\ Neighbor cell with abs ( {P}_{RSI} - {N}_{n} ) < {R}_{RSI}\end{matrix}}{Total coverage area of candidate cell} .$$

16. The random access channel planning node of claim 11, further comprising:
creating a plurality of groups of all root sequence indexes for all cells of the greenfield radio access network, wherein each group has a group number and includes a defined subset of all of the root sequence indexes;
generating a number of clusters of all of the cells of the greenfield radio access network based on physical site meta data of all of the cells, wherein each cluster comprises a subset of all of the cells defined by the minimum count of root sequence indexes in the created groups and where all cells of a site of the greenfield communication network remain in the same cluster;
for each cluster, selecting the group number that is equal to (cluster number) MOD (the defined number of random access channel preambles for the candidate cell); and
repeating for a cluster candidate cell in each cluster, the identifying, the using, and the initiating for the cluster candidate cell in each cluster.

17. The random access channel planning node of claim 11, wherein the identifying comprises:
for each of the candidate cell and the neighboring cells of the candidate cell, obtaining geo-located measurements and physical site meta data from the communication network for the candidate cell and the neighboring cells of the candidate cell for an operational radio access network;
for each of the candidate cell and the neighboring cells of the candidate cell, identifying a coverage polygon of the candidate cell and the neighboring cells of the candidate cell based on a contour of the geo-located measurements and the physical meta data for the candidate cell and the neighboring cells of the candidate cell where signal strength is greater than or equal to a defined signal strength;
calculating an area of intersection of the identified coverage polygons for the candidate cell and the neighboring cells of the candidate cell; and
identifying the calculated area of intersection as the coverage overlap area of the candidate cell with the neighboring cells of the candidate cell.

18. The random access channel planning node of claim 17, wherein the deriving the second list of root sequence indexes from the first list comprises all of the root sequence indexes from the first list.

19. The random access channel planning node of claim 11, further comprising:
determining a success rate of a random access channel of a cell in the radio access network based on performance measurements received from the cell; and
determining whether the success rate of the random access channel of the cell is less than a specified value.

20. The random access channel planning node of claim 19, further comprising:
if the success rate of the random access channel of the cell is less than the specified value, identifying the cell as the candidate cell; and
performing the identifying, the using, and the initiating for the candidate cell.

21. A random access channel planning node, the random access channel planning node being configured to:
identify a coverage overlap area of a candidate cell with each of the neighboring cells of the candidate cell in a radio access network;
use the identified coverage overlap area to determine a root sequence index for the candidate cell having a minimum root sequence index collision factor; and
initiate a command to the candidate cell to set the root sequence index for the candidate cell to the determined root sequence index having the minimum root sequence index collision factor.

22. The random access channel planning node of claim 21, wherein the use comprises:
prepare a first list of root sequence indexes for neighboring cells having coverage overlap areas with the candidate cell;
derive a second list of the root sequence indexes from the first list, wherein the number of root sequence indexes in the second list is based on a defined number of root sequence indexes for generating a defined number of preambles for the candidate cell;
calculate a root sequence index collision factor for the candidate cell for each root sequence index in the second list; and
determine the root sequence index having the minimum root sequence index collision factor for the candidate cell.

23. The random access channel planning node of claim 21, wherein the identify comprises:
for each of the candidate cell and the neighboring cells of the candidate cell, obtain a coverage prediction plot and physical site meta data for the candidate cell and the neighboring cells for a greenfield radio access network;
for each of the candidate cell and the neighboring cells of the candidate cell, identify a coverage polygon for the candidate cell and the neighboring cells of the candidate cell based on the coverage prediction plot and the physical site meta data for the candidate cell and the neighboring cells of the candidate cell;
calculate an area of intersection of the identified coverage polygons for the candidate cell and the neighboring cells of the candidate cell; and
identify the calculated area of intersection as the coverage overlap area of the candidate cell with the neighboring cells of the candidate cell.

24. The random access channel planning node of claim 22, wherein the derive a second list of the root sequence indexes from the first list comprises calculating a subset of the root sequence indexes, L_{CAND}, from the first list to generate a defined number of random access channel preambles for the candidate cell; and
wherein each root sequence index for the candidate cell, P_{RSI}, is included in the subset, L_{CAND}, so that an absolute value of a difference between each root sequence index for the candidate cell, P_{RSI}, and each root sequence index for a neighbor cell, N_{RSI}, having a coverage overlap area with the candidate cell, Nₙ, is less than R_{RSI}, the defined number of root sequence indexes for generating a defined number of preambles for the candidate cell.

25. The random access channel planning node of claim 24, wherein the calculate the root sequence index collision factor for the candidate cell for each root sequence index in the second list comprises:
calculating the root sequence index collision factor, Fc, for each root sequence index included in the second list using the equation
$$Fc = \frac{\begin{matrix}{\sum }_{n = 1}^{x} Area of coverage overlap with \\ Neighbor cell with abs ( {P}_{RSI} - {N}_{n} ) < {R}_{RSI}\end{matrix}}{Total coverage area of candidate cell} .$$

26.-32. (canceled)
